(19) United States
(12) Patent Application Publication
(10) Pub. No.: US 2025/0113370 A1
(43) Pub. Date: Apr. 3, 2025

(54) TRIGGERED P2P WITH QoS CHARACTERISTICS

(71) Applicant: Samsung Electronics Co., Ltd., Suwon-si (KR)

(72) Inventors: Rubayet Shafin, Frisco, TX (US); Boon Loong Ng, Plano, TX (US); Vishnu Vardhan Ratnam, Plano, TX (US); Peshal Nayak, Plano, TX (US); Yue Qi, Plano, TX (US)

(21) Appl. No.: 18/814,405

(22) Filed: Aug. 23, 2024

Related U.S. Application Data
(60) Provisional application No. 63/541,696, filed on Sep. 29, 2023.
(60) Provisional application No. 63/552,501, filed on Feb. 12, 2024.
(60) Provisional application No. 63/553,512, filed on Feb. 14, 2024.

(51) Int. Cl. H04W 72/50; H04L 67/104; H04W 72/543

(52) U.S. Cl. CPC H04W 72/535; H04L 67/104; H04W 72/543

(57) ABSTRACT

An access point (AP) in a wireless network, the AP comprising a memory and a processor coupled to the memory, the processor configured to receive, from a station (STA), a first frame that requests assistance for peer-to-peer (P2P) communication and includes quality of service (QoS) information for the P2P communications, and transmit, to the STA, a second frame that is a trigger frame that allocates a transmission opportunity (TXOP) to the STA to transmit P2P communications with another STA.

### CROSS-REFERENCE TO RELATED APPLICATIONS

This application claims the benefit of priority from U.S. Provisional Application No. 63/541,696, entitled “Triggered P2P with QoS Characteristics” filed Sep. 29, 2023, U.S. Provisional Application No. 63/552,501, entitled “Triggered P2P with QoS Characteristics” filed Feb. 12, 2024, and U.S. Provisional Application No. 63/553,512, entitled “Triggered P2P with QoS Characteristics” filed Feb. 14, 2024, all of which are incorporated herein by reference in their entireties.

### TECHNICAL FIELD

This disclosure relates generally to a wireless communication system, and more particularly to, for example, but not limited to, triggered peer-to-peer (P2P) communication with QoS characteristics.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides an access point (AP) in a wireless network. The AP comprises a memory and a processor coupled to the memory. The processor is configured to receive, from a station (STA), a first frame that requests assistance for peer-to-peer (P2P) communication and includes quality of service (QoS) information for the P2P communications. The processor is configured to transmit, to the STA, a second frame that is a trigger frame that allocates a transmission opportunity (TXOP) to the STA to transmit P2P communications with another STA.

In some embodiments, the first frame is a stream classification service (SCS) request frame that includes a QoS Characteristics element.

In some embodiments, a direction subfield in the QoS characteristics element is set to direct link and a link is indicated where the STA intends to transmit P2P frames.

In some embodiments, the second frame is a multi-user request-to-send (MU-RTS) triggered TXOP sharing (TXS) trigger frame.

In some embodiments, the AP is affiliated with a AP multi-link device (MLD).

In some embodiments, the QoS information comprises a service internal, a minimum data rate, or a delay bound within which latency-sensitive P2P traffic needs to be delivered.

One aspect of the present disclosure provides a first station (STA) in a wireless network. The first STA comprises a memory and a processor coupled to the memory. The processor is configured to form a peer-to-peer (P2P) link with a second STA for P2P communications. The processor is configured to transmit, to an access point (AP), a first frame that requests assistance for the P2P communications and includes quality of service (QoS) information for the P2P communications. The processor is configured to receive, from the AP, a second frame that is a trigger frame that allocates a transmission opportunity (TXOP) to the first STA for the P2P communications with the second STA. The processor is configured to perform the P2P communication with the second STA using the allocated TXOP.

In some embodiments, the first frame is a stream classification service (SCS) request frame that includes a QoS Characteristics element.

In some embodiments, a direction subfield in the QoS characteristics element is set to direct link and a link is indicated where the first STA intends to transmit P2P frames.

In some embodiments, the second frame is a multi-user request-to-send (MU-RTS) triggered TXOP sharing (TXS) trigger frame.

In some embodiments, the first STA is affiliated with a non-AP multi-link device (MLD).

In some embodiments, the QoS information comprises a service internal, a minimum data rate, or a delay bound within which latency-sensitive P2P traffic needs to be delivered.

In some embodiments, the processor is further configured to determine that there is no pending physical layer protocol data unit (PPDU) for the P2P communication with the second STA, and return the TXOP to the AP.

In some embodiments, the processor is further configured to transmit PPDUs for the P2P communication using enhanced distributed channel access (EDCA) based contention method.

In some embodiments, the PPDUs transmitted using the EDCA based contention method are transmitted with lower priority EDCA parameters.

One aspect of the present disclosure provides a computer-implemented method for peer-to-peer (P2P) communication at a first station (STA) in a wireless network. The method comprises forming a P2P link with a second STA for P2P communications. The method comprises transmitting, to an access point (AP), a first frame that requests assistance for the P2P communications and includes quality of service (QoS) information for the P2P communications. The method comprises receiving, from the AP, a second frame that is a trigger frame that allocates a transmission opportunity (TXOP) to the first STA for the P2P communications with the second STA. The method comprises performing the P2P communication with the second STA using the allocated TXOP.

In some embodiments, the first frame is a stream classification service (SCS) request frame that includes a QoS Characteristics element.

In some embodiments, a direction subfield in the QoS characteristics element is set to direct link and a link is indicated where the first STA intends to transmit P2P frames.

In some embodiments, the second frame is a multi-user request-to-send (MU-RTS) triggered TXOP sharing (TXS) trigger frame.

In some embodiments, the first STA is affiliated with a non-AP multi-link device (MLD).

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a network with different types of traffic in accordance with an embodiment.

FIG. 5 illustrates an environment with latency-sensitive P2P traffic in accordance with an embodiment.

FIG. 6A illustrates an SCS request frame in accordance with an embodiment.

FIG. 6B illustrates a QoS Characteristics element in accordance with an embodiment of the invention.

FIG. 6C illustrates a structure of a Control Info field of a QoS Characteristics element in accordance with an embodiment of the invention.

FIG. 7 illustrates a triggered P2P communication with SCS procedure (including a QoS Characteristics element) in accordance with an embodiment.

FIG. 8 illustrates a flow chart of an example STA-side process for triggered P2P with QoS characteristics in accordance with an embodiment.

FIG. 9 illustrates a flow chart of an example AP-side process for triggered P2P with QoS characteristics in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

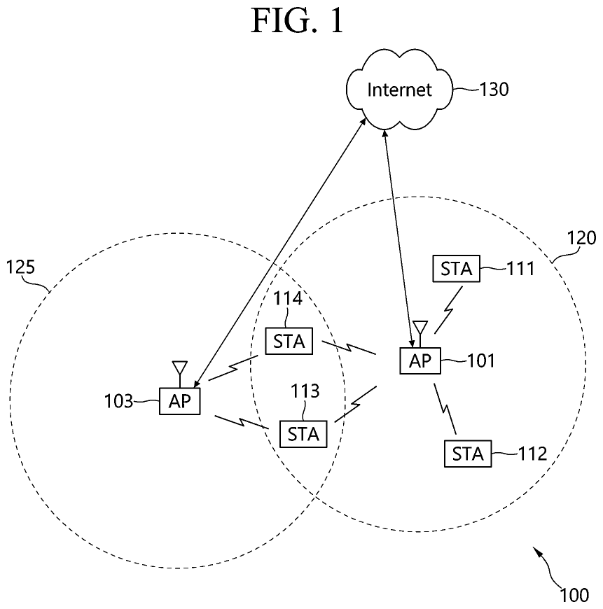

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

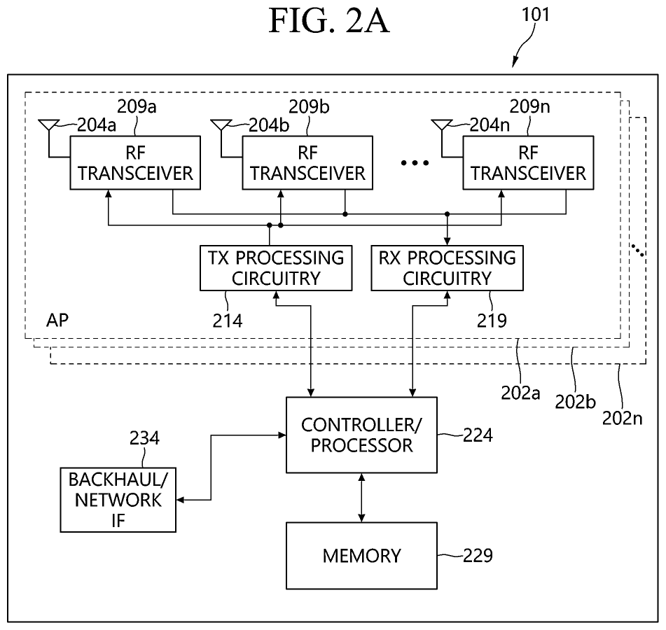

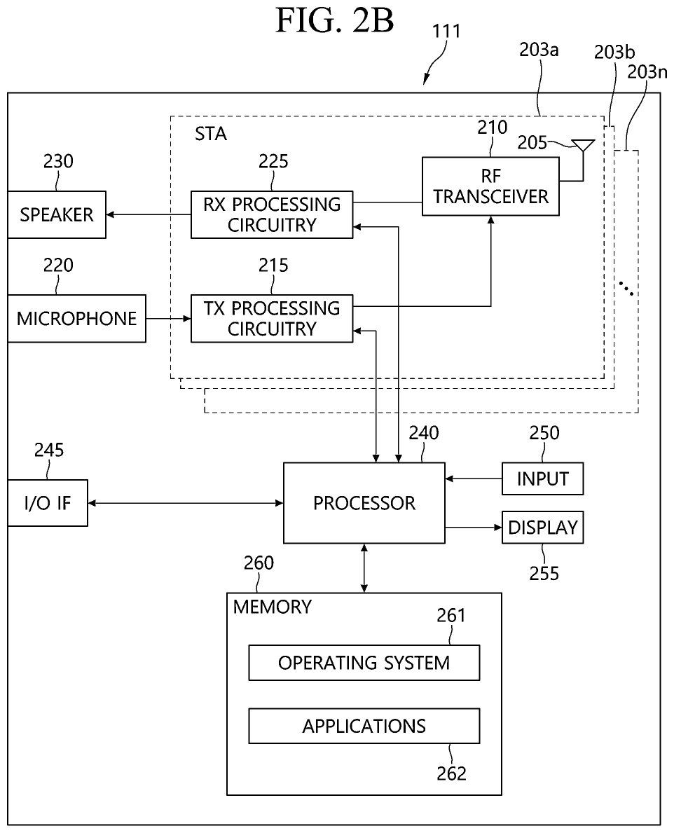

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

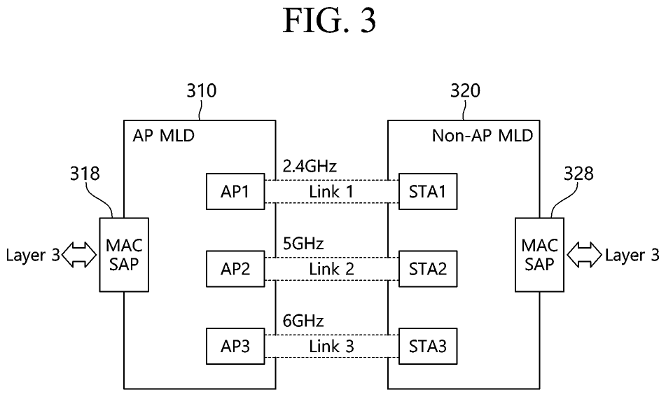

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

Next generation WLAN systems may benefit from providing better support for low-latency applications. In particular, it is not uncommon to observe numerous devices operating on a same network, where different devices have different latency requirements. Many of such devices may be latency-tolerant but may still contend with devices that have low-latency applications for the same time and frequency resources. In some cases, the access point (AP) as the network controller may not have enough control over the unregulated/unmanaged traffic that contend with the low-latency traffic within the infrastructure basic service set (BSS). Some of the unmanaged traffic that interfere with the AP's BSS' latency sensitive traffic may be coming from uplink (UL)/downlink (DL) or direct link communications within the infrastructure BSS that the AP manages. Other interference may be due to transmission in a neighboring infrastructure BSS (OBSS). Yet other interference may be coming from a neighboring independent BSS or peer-to-peer (P2P) network.

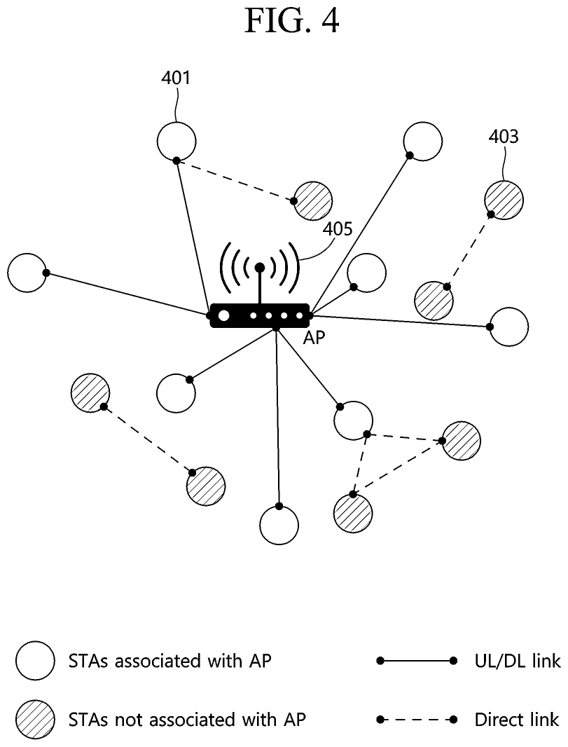

FIG. 4 illustrates a network with different types of traffic in accordance with an embodiment. In particular, FIG. 4 illustrates a network with an AP 405 and numerous STAs, where certain STAs, such as STA 401, are associated with the AP, as indicated by the key in the figure. Certain STAs, such as STA 403, are not associated with the AP. Furthermore, as indicated by the key, the STAs associated with the AP may have an UL/DL link with the AP, as illustrated by the solid lines connecting the STAs with the AP. Certain STAs may have a direct link with other STAs as indicated by the dashed lines.

As described herein, P2P technologies such as Wi-Fi Direct, Wi-Fi Aware, or TDLS, among others, may enable devices to communicate with each other through direct Wi-Fi interfaces without the need to route the traffic through the infrastructure APs. P2P technologies may be well suited to various latency-sensitive use cases such as X-reality (XR) applications (e.g. data exchange between the a head-mounted device (HMD) and the compute device) or high-definition video applications (e.g., Miracast over Wi-Fi Direct or Wi-Fi Aware, among others), and provide enhanced user experience by improving QoS parameters such as latency through the use of the direct links.

Latency-sensitive application traffic, such as XR traffic or video traffic, is typically periodic with a particular QoS characteristic. When the network is congested, it is highly probable that the P2P QoS will not be met due to the heavy channel contentions among the non-AP STAs and the APs. In some embodiments, to enhance the support of P2P QoS, a non-AP STA can inform the AP about the required QoS parameters for the latency-sensitive P2P traffic, such as service interval, minimum data rate, delay bound, and other information. The AP can then facilitate the non-AP STA's P2P QoS fulfillment by appropriately sending trigger frames to the non-AP STA. In particular, in a WLAN system with moderate or heavy traffic flow, a STA may not be able to get a chance to deliver its peer-to-peer (P2P) traffic in a timely manner. If the STA has latency-sensitive traffic for another peer device, this may need to be delivered within a given delay bound. Accordingly, not being able to access the channel for P2P communication can disrupt the latency-sensitive applications.

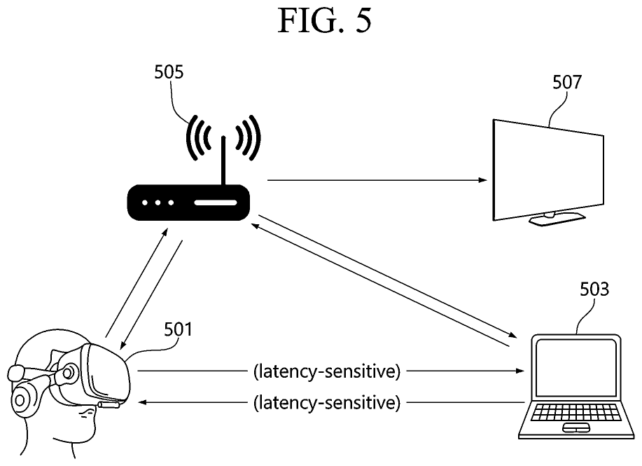

FIG. 5 illustrates an environment with latency-sensitive P2P traffic in accordance with an embodiment. In particular, FIG. 5 illustrates an example scenario of augmented reality, virtual reality, extended reality, mixed reality (AR/VR/XR/MR) communication with a device using P2P communication. The head-mounted device (HMD) 501 and the companion device 503 (the laptop) may have latency-sensitive P2P traffic. The access point (AP) 505 may be delivering downlink traffic to other nodes 507 and other nodes 507 may also be transmitting uplink traffic. As such, the channel may be occupied, and as a result, the latency-sensitive P2P traffic between the HMD 501 and the laptop device 503 may not be able to be delivered. Accordingly, embodiments in accordance with this disclosure may provide one or more protocols to ensure the effective delivery of time-sensitive P2P traffic. Efficient and effective P2P communication may be important for various applications. In existing techniques, an AP is essentially hands-off for P2P communications in the network. As such, in a congested network, this may inhibit the timely delivery of P2P traffic.

In some embodiments, when a latency-sensitive P2P application starts, the STA can inform the AP about the corresponding P2P QoS requirement. In some embodiments, the STA may transmit a QoS characteristics element to the AP in a stream classification service (SCS) Request frame. In some embodiments, a Direction subfield in the QoS Characteristics element can be set to “Direct Link”.

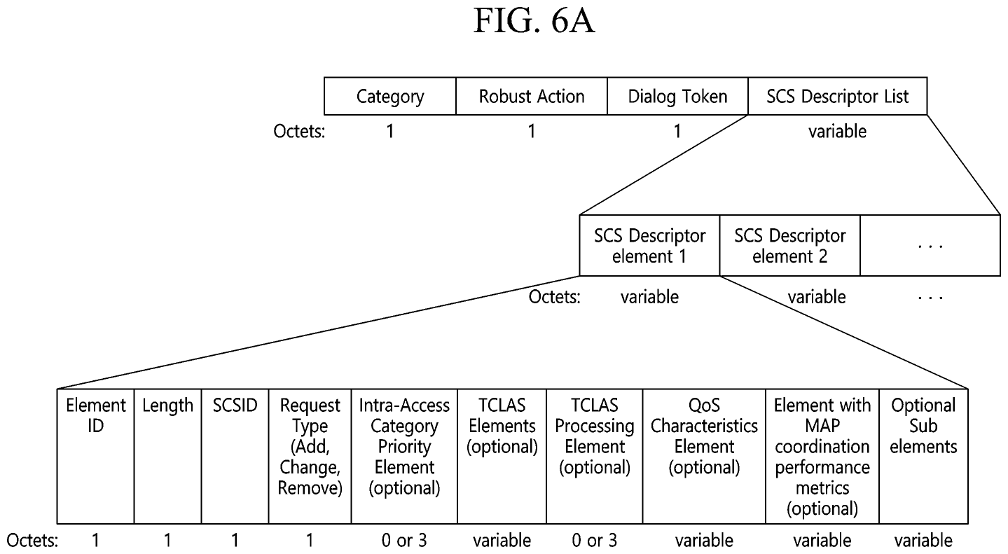

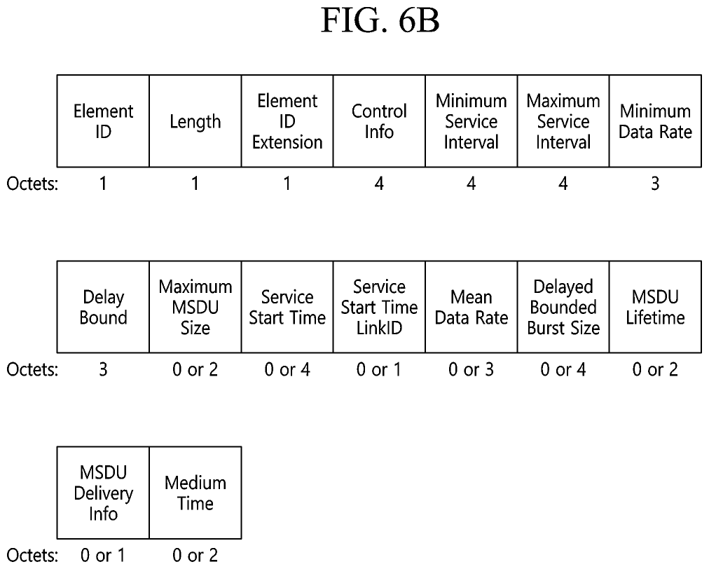

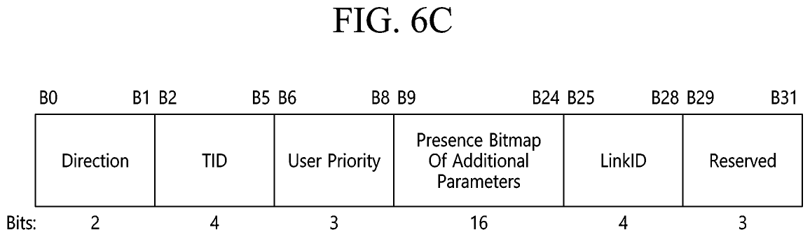

FIG. 6A illustrates an SCS request frame in accordance with an embodiment. The frame can include a Category field, a Robust Action field, a Dialog Token field, and an SCS descriptor list field.

The Category field may be set to a value that indicates a category of the SCS request frame that is an action frame. The Robust Action field may have a value associated with the SCS request frame format within predefined robust AV streaming category. The Dialog Token field may be used for matching action response with action requests when there are multiple, concurrent action requests. The SCS Descriptor List field may include one or more SCS Descriptor elements.

In particular, the SCS Descriptor element can include an Element ID field, Length field, SCSID field, Request Type field, Intra-Access Category Priority element field (optional), TCLAS elements field (optional), TCLAS processing clement field (optional), QoS Characteristics element field (optional), Element with MAP Coordination Performance Metrics field (optional) and Optional Sub elements field.

The Element ID field may include information to identify a type of the SCS Descriptor element. The Length field may indicate a length of the SCS Descriptor element. The SCSID field may include information to identify the SCS descriptor element. The Request Type field can be set to indicate the request type (i.e., Add, Remove, and Change) of the SCS descriptor element. The Intra-Access Category Priority clement field may be present when the Request Type field is equal to “Add” or “Change.” The TCLAS clement field may include information on a traffic classification. The TCLAS processing element field may include information on a method of processing a traffic from an upper layer. The QoS Characteristics element field may include a set of parameters that define the characteristics and QoS expectations of a traffic flow. The Element with MAP Coordination Performance Metrics field can include information related to performance metrics that can be used for multi-AP coordination. Many embodiments can include information in an independent frame and/or other types of frames.

FIG. 6B illustrates a QoS Characteristics clement in accordance with an embodiment of the invention. The QoS Characteristics clement can include an Element ID field, a Length field, an Element ID extension field, a Control Info field, a Minimum Service Interval field, a Maximum Service Interval field, a Minimum Data Rate field, a Delay Bound field, a Maximum MAC Service Data Unit (MSDU) Size field, a Service Start Time field, a Service Start Time Link ID field, a Mean Data Rate field, a Delayed Bounded Burst Size field, a MSDU Lifetime field, a MSDU Delivery Info field, a Medium Time field.

The Element ID field can provide an identifier for the element. The length field can provide length information of the clement. The Element ID Extension field can provide an identifier extension for the element. The Control Info field can provide control information of the element and can include several subfields, which are illustrated in FIG. 6C. The Minimum Service Interval field can provide a minimum service interval of the element. The Minimum Data Rate field can provide a minimum date rate of the clement. The Delay Bound field can provide delay information for the element including a maximum amount of time targeted to transport an MSDU belonging to the traffic flow described by this element. The Maximum MSDU Size can provide a maximum MSDU size information of an MSDU belonging to the traffic flow described by this element. The Service Start Time field can provide a service start time information for the element, including an anticipated time when the traffic starts for the associated TID. The Mean Data Rate field can provide a mean data rate for the element and can indicate an average data rate for transport of MSDUs belonging to the traffic flow described by this element. The MSDU Lifetime field can provide MSDU lifetime information for the element and can specify a maximum amount of time since the arrival of the MSDU beyond which the MSDU is not useful even if received by the receiver. The MSDU Delivery Info field can provide MSDU delivery information for the element. The Medium Time can provide medium time information for the element and can specify a medium time, in units of 256 microseconds per second, requested by an STA as the average medium time needed in each second.

FIG. 6C illustrates a structure of a Control Info field of a QoS Characteristics element in accordance with an embodiment of the invention. The Control Info field can include a Direction field, a TID field, a User Priority field, a Presence Bitmap of Additional Parameters field, a Link ID field, and a Reserved field. The Direction field can specify a direction of data for the element, which may include “0” for uplink, “1” for downlink, “2” for direct link, and “3” for reserved. The TID field can provide include a TID value of the data frames that are described by this element. The User Priority field can provide a user priority value of the data frames that are described by this element. The Presence Bitmap of Additional Parameters field can include a bitmap where the i-th entry of the bitmap is set to 1 if the i-th field starting from the Maximum MSDU Size field is present in this element. The Link ID field may include the link identifier that corresponds to the link for which the direct link transmissions are going to occur. The Reserved field may be reserved.

In some embodiments, the AP can successfully receive the QoS Characteristics element from the STA in the SCS Request frame. In some embodiments, if the SCS request is accepted by the AP, then the AP can schedule a multi-user request-to-send (MU-RTS) triggered transmission opportunity sharing (TXS) (Mode-2) trigger frame to the STA that sent the SCS Request frame. In some embodiments, for an MU-RTS TXS trigger frame, a Mode-1 transmission mode may allow only uplink transmission by a non-AP STA using an allocated TXOP and a Mode-2 transmission mode may allow both uplink and P2P transmission by a non-AP STA using the allocated TXOP. In some embodiments, the MU-RTS TXS (Mode-2) trigger frame may be according to the QoS parameters specified in the QoS Characteristics clement carried in the SCS Request frame to facilitate the fulfillment of the STA's P2P QoS requirement.

In some embodiments, after receiving the MU-RTS TXS (Mode-2) trigger frame, within the allocated transmit opportunity (TXOP) duration, the STA can transmit to the peer STA using the allocated TXOP if it has P2P physical layer protocol data units (PPDUs) in the buffer. In some embodiments, if the STA does not have any pending PPDU for any of its peer STAs, then the STA can return the TXOP to the AP. In some embodiments, a STA that sends the SCS and can receive the subsequent TXOP from the AP for P2P transmission, may still transmit P2P PPDUs using a contention method. For example, using enhanced distributed channel-access (EDCA) based contention. In some embodiments, a STA that sends the SCS and can receive the subsequent TXOP from the AP for P2P transmission, may not transmit P2P PPDUs using a contention method (e.g., EDCA-based). In some embodiments, a STA that sends the SCS and can receive the subsequent TXOP from the AP for P2P transmission, may still transmit P2P PPDUs using contention (e.g., EDCA method) but with lower priority EDCA parameters (e.g. using MU-EDCA procedure).

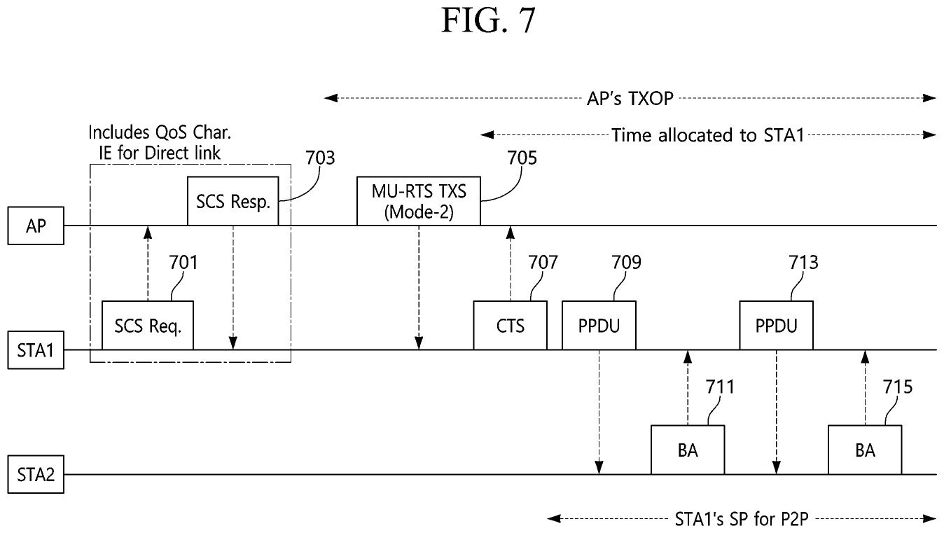

FIG. 7 illustrates a triggered P2P communication with SCS procedure (including a QoS Characteristics element) in accordance with an embodiment. In FIG. 7, STA1 and STA2 form a P2P link. STA1 can be associated with the AP. STA1 informs the AP about its P2P QoS requirements. In some embodiments, STA1 may send an SCS Request frame 701 to the AP including a QoS Characteristics element with Direction Subfield set to “Direct Link” configuration. In some embodiments, other parameters of the QoS Characteristics element can reflect the STA1's P2P QoS requirements. The AP may evaluate the SCS request frame 701 and send a SCS Response frame 703 to STA1 with an “accept” indication. Subsequently the AP may send an MU-RTS TXS trigger frame (Mode-2) 705 to STA1 such that the STA1 can deliver its P2P traffic to its peer to satisfy the requirements according to the parameters in the QoS Characteristics element. Subsequently, STA1 may receive the TXOP from the AP (by receiving the MU-RTS TXS trigger frame) and transmits to its peer, STA2, using the TXOP. As illustrated STA1 transmits a clear-to-send frame 707 to AP. Then STA1 transmits a PPDU 709 to STA2 and STA2 transmits a block acknowledgment (BA) 711 to STA1. STA1 then transmits a PPDU 713 to STA2 and STA2 transmits BA 715 to STA1.

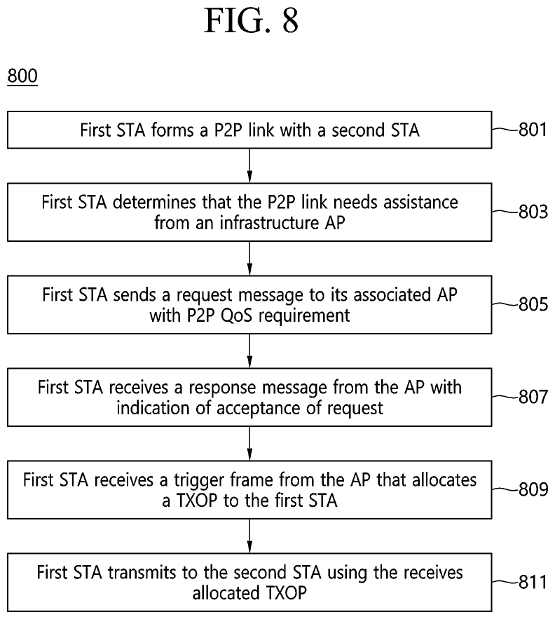

FIG. 8 illustrates a flow chart of an example STA-side process for triggered P2P with QoS characteristics in accordance with an embodiment. Although one or more operations are described or shown in particular sequential order, in other embodiments the operations may be rearranged in a different order, which may include performance of multiple operations in at least partially overlapping time periods. The flowchart depicted in FIG. 8 illustrates operations performed by a STA.

The process 800, in operation 801, the first STA forms a P2P link with a second STA.

In operation 803, the first STA determines that the P2P link needs assistance from an infrastructure AP.

In operation 805, the first STA sends a request message to its associated AP with its P2P QoS requirement. In some embodiments, the first STA can transmit an SCS Request frame to the AP that includes a QoS Characteristics element. In some embodiments, a Direction subfield of the QoS Characteristics clement can be set to “Direct Link” configuration.

In operation 807, the first STA receives a response message from the AP with an indication of acceptance of the request. In some embodiments, the response message is an SCS Response frame with an indication of acceptance of the SCS request.

In operation 809, the first STA receives a trigger frame from the AP that allocates a TXOP to the first STA. In some embodiments, the trigger frame is a MU-RTS TXS Trigger frame (Mode-2) that allocates a TXOP to the first STA. In some embodiments, the TXOP can be according to the parameters in the QoS Characteristics element.

In operation 811, the first STA transmits to the second STA using the received allocated TXOP.

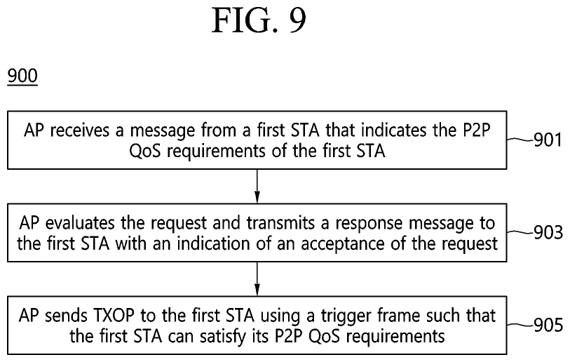

FIG. 9 illustrates a flow chart of an example AP-side process for triggered P2P with QoS characteristics in accordance with an embodiment. Although one or more operations are described or shown in particular sequential order, in other embodiments the operations may be rearranged in a different order, which may include performance of multiple operations in at least partially overlapping time periods. The flowchart depicted in FIG. 8 illustrates operations performed by an AP.

The process 900, in operation 901, the AP receives a message from a first STA that indicates the P2P QoS requirements of the first STA. In some embodiments, message may be an SCS Request frame that includes a QoS Characteristics element, with a Direction subfield of the QoS Characteristics element set to “Direct Link” configuration.

In operation 903, the AP evaluates the request and transmits a response message to the first STA with an indication of an acceptance of the request. In some embodiments, the response message may be an SCS Response frame.

In operation 905, the AP sends a TXOP to the first STA using a trigger frame such that the first STA can satisfy its P2P QoS requirements. In some embodiments, the trigger frame may be an MU-RTS TXS Trigger frame (Mode-2).

In some embodiments, a P2P QoS provisioning can be negotiated between an AP affiliated with an AP MLD and a STA affiliated with a non-AP MLD. In some embodiments, a STA affiliated with a non-AP MLD may indicate its support for the P2P QoS provisioning feature by using specific signaling in the EHT Capabilities element it transmits.

In some embodiments, when a latency-sensitive P2P application starts, a STA affiliated with a non-AP MLD that supports the P2P QoS provisioning feature may inform the associated AP MLD about the corresponding P2P QoS requirement by transmitting a QoS Characteristics element to the AP MLD in an SCS Request frame. In some embodiments, the Direction subfield of the QoS Characteristics element shall be set to 2 (e.g., direct link) which may be transmitted to the AP MLD if the associated AP affiliated with the AP MLD also supports this feature. In some embodiments, if the SCS request is accepted by the AP MLD, the STA shall successfully process a subsequent MU-RTS TXS (Mode-2) trigger frame received from the AP MLD.

In some embodiments, within the allocated TXOP duration as indicated in the received MU-RTS TXS (Mode-2) trigger frame, the STA transmits to its peer STA if it has P2P PPDUs in the buffer.

In some embodiments, an AP affiliated with an AP MLD indicates its support for the P2P QoS provisioning feature by using specific signaling in the EHT Capabilities element it transmits. In some embodiments, the AP affiliated with an AP MLD that supports the P2P QoS provisioning feature shall receive and process the QoS Characteristics clement from a STA affiliated with a non-AP MLD in an SCS Request frame, where the Direction subfield of the QoS Characteristics clement is set to 2 (Direct link). In some embodiments, if the SCS request is accepted by the AP MLD, then the AP should schedule MU-RTS TXS (Mode-2) trigger frames to the STA (according to the QoS parameters specified in the QoS Characteristics element) to facilitate the fulfillment of the STA's P2P QoS requirement.

In some embodiments, the P2P QoS provisioning can be negotiated between an AP MLD and a non-AP MLD. In some embodiments, an AP affiliated with an AP MLD my indicate its support for the P2P QoS provisioning feature by using specific signaling in the transmitted EHT Capabilities element. In some embodiments, an AP MLD indicates support for the P2P QoS provisioning feature through an affiliated AP by using specific signaling in the EHT Capabilities element. In some embodiments, the AP MLD may process the QoS Characteristics element in an SCS Request frame received from the non-AP MLD, where the Direction subfield of the QoS Characteristics element is set to 2 (Direct link) and a link is indicated where a STA affiliated with the non-AP MLD is operating with the AP. In some embodiments, if the SCS request is accepted by the AP MLD, then the AP MLD shall demonstrate that it is capable of scheduling MU-RTS TXS (Mode-2) trigger frames to the STA (according to the QoS parameters specified in the QoS Characteristics element) to facilitate the fulfillment of the STA's P2P QoS requirement.

In some embodiments, a STA affiliated with a non-AP MLD and operating on a link with an AP affiliated with an AP MLD indicates its support for the P2P QoS provisioning feature by using specific signaling in the transmitter EHT Capabilities element. In some embodiments, a non-AP MLD indicates support for the P2P QoS provisioning feature by using specific signaling in the EHT Capabilities element transmitted to an AP MLD on a link through an affiliated STA to an affiliated AP. In some embodiments, when a latency-sensitive P2P application starts, the non-AP MLD may inform the associated AP MLD about the corresponding P2P QoS requirement by transmitting a QoS Characteristics clement to the AP MLD in an SCS Request frame (the Direction subfield of the QoS Characteristics clement shall be set to 2 (Direct link)) transmitted to the AP MLD and indicates the link on which the STA is operating. In some embodiments, if the SCS request is accepted by the AP MLD, the STA shall successfully process a subsequent MU-RTS TXS (Mode-2) trigger frame received from the AP affiliated with the AP MLD. In some embodiments, within the allocated TXOP duration as indicated in the received MU-RTS TXS (Mode-2) trigger frame, the STA transmits to its peer STA if it has P2P frames in the buffer.

In some embodiments, an AP MLD indicates support for the P2P QoS Provisioning feature through an affiliated AP by using specific signaling in the EHT Capabilities element for triggered TXOP sharing (mode-2) and related SCS procedures. In some embodiments, the AP MLD shall process the QoS Characteristics element in an SCS Request frame received from the non-AP MLD, where the Direction subfield of the QoS Characteristics clement is set to 2 (Direct link) and a link is indicated where a STA affiliated with the non-AP MLD intends to transmit P2P frames. In some embodiments, if the SCS request is accepted by the AP MLD, then the AP MLD shall demonstrate that it is capable of scheduling MU-RTS TXS (Mode-2) Trigger frames to the STA (according to the QoS parameters specified in the QoS Characteristics element) to facilitate the fulfillment of the STA's P2P QoS requirement. In some embodiments, a non-AP MLD may indicate support for the P2P QoS Provisioning feature by using specific signaling for triggered TXOP sharing (mode-2) and related SCS procedures in the EHT Capabilities element transmitted to an AP MLD on a link through an affiliated STA to an AP affiliated with the AP MLD.

In some embodiments, when a latency-sensitive P2P application starts, the non-AP MLD may inform the associated AP MLD about the corresponding P2P QoS requirement by transmitting a QoS Characteristics element to the AP MLD in an SCS Request frame (the Direction subfield of the QoS Characteristics element shall be set to 2 (Direct link)) transmitted to the AP MLD and indicates a link on which the P2P transmission will occur. In some embodiments, if the SCS request is accepted by the AP MLD, the STA shall successfully process a subsequent MU-RTS TXS (Mode-2) trigger frame received from the AP MLD on the indicated link

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, the AP comprising:
a memory;
a processor coupled to the memory, the processor configured to:
receive, from a station (STA), a first frame that requests assistance for peer-to-peer (P2P) communication and includes quality of service (QoS) information for the P2P communications;
transmit, to the STA, a second frame that is a trigger frame that allocates a transmission opportunity (TXOP) to the STA to transmit P2P communications with another STA.

2. The AP of claim 1, wherein the first frame is a stream classification service (SCS) request frame that includes a QoS Characteristics element.

3. The AP of claim 2, wherein a direction subfield in the QoS characteristics element is set to direct link and a link is indicated where the STA intends to transmit P2P frames.

4. The AP of claim 1, wherein the second frame is a multi-user request-to-send (MU-RTS) triggered TXOP sharing (TXS) trigger frame.

5. The AP of claim 1, wherein the AP is affiliated with an AP multi-link device (MLD).

6. The AP of claim 1, wherein the QoS information comprises a service internal, a minimum data rate, or a delay bound within which latency-sensitive P2P traffic needs to be delivered.

7. A first station (STA) in a wireless network, the first STA comprising:
a memory;
a processor coupled to the memory, the processor configured to:
form a peer-to-peer (P2P) link with a second STA for P2P communications;
transmit, to an access point (AP), a first frame that requests assistance for the P2P communications and includes quality of service (QoS) information for the P2P communications;
receive, from the AP, a second frame that is a trigger frame that allocates a transmission opportunity (TXOP) to the first STA for the P2P communications with the second STA; and
perform the P2P communication with the second STA using the allocated TXOP.

8. The first STA of claim 7, wherein the first frame is a stream classification service (SCS) request frame that includes a QoS Characteristics element.

9. The first STA of claim 8, wherein a direction subfield in the QoS characteristics element is set to direct link and a link is indicated where the first STA intends to transmit P2P frames.

10. The first STA of claim 7, wherein the second frame is a multi-user request-to-send (MU-RTS) triggered TXOP sharing (TXS) trigger frame.

11. The first STA of claim 7, wherein the first STA is affiliated with a non-AP multi-link device (MLD).

12. The first STA of claim 7, wherein the QoS information comprises a service internal, a minimum data rate, or a delay bound within which latency-sensitive P2P traffic needs to be delivered.

13. The first STA of claim 7, wherein the processor is further configured to:
determine that there is no pending physical layer protocol data unit (PPDU) for the P2P communication with the second STA; and
return the TXOP to the AP.

14. The first STA of claim 13, wherein the processor is further configured to: transmit PPDUs for the P2P communication using enhanced distributed channel access (EDCA) based contention method.

15. The first STA of claim 14, wherein the PPDUs transmitted using the EDCA based contention method are transmitted with lower priority EDCA parameters.

16. A computer-implemented method for peer-to-peer (P2P) communication at a first station (STA) in a wireless network, the method comprising:
forming a P2P link with a second STA for P2P communications;
transmitting, to an access point (AP), a first frame that requests assistance for the P2P communications and includes quality of service (QoS) information for the P2P communications;
receiving, from the AP, a second frame that is a trigger frame that allocates a transmission opportunity (TXOP) to the first STA for the P2P communications with the second STA; and
performing the P2P communication with the second STA using the allocated TXOP.

17. The computer-implemented method of claim 16, wherein the first frame is a stream classification service (SCS) request frame that includes a QoS Characteristics element.

18. The computer-implemented method of claim 17, wherein a direction subfield in the QoS characteristics element is set to direct link and a link is indicated where the first STA intends to transmit P2P frames.

19. The computer-implemented method of claim 16, wherein the second frame is a multi-user request-to-send (MU-RTS) triggered TXOP sharing (TXS) trigger frame.

20. The computer-implemented method of claim 16, wherein the first STA is affiliated with a non-AP multi-link device (MLD).
